(19) United States
(12) Patent Application Publication
(10) Pub. No.: US 2022/0358293 A1
(43) Pub. Date: Nov. 10, 2022

(54) ALIGNMENT OF VALUES AND OPINIONS BETWEEN TWO DISTINCT ENTITIES

(71) Applicants: Gregory Renard, REDWOOD CITY, CA (US); Samuel Rince, Orsay (FR); Antonio Loison, Lisboa (PT); Sandrine Chausson, London (GB); Tresor Djigui, Roissy-En-Brie (FR)

(72) Inventors: Gregory Renard, REDWOOD CITY, CA (US); Samuel Rince, Orsay (FR); Antonio Loison, Lisboa (PT); Sandrine Chausson, London (GB); Tresor Djigui, Roissy-En-Brie (FR)

(21) Appl. No.: 17/308,135

(22) Filed: May 5, 2021

(51) Int. Cl. G06F 40/30; G06F 16/951; G06N 3/04; G06Q 30/02; G06F 16/35; G06F 16/36

(52) U.S. Cl. CPC G06F 40/30; G06F 16/951; G06N 3/0454; G06Q 30/0201; G06F 16/353; G06F 16/36

(57) ABSTRACT

A method to determine alignment between first and second entities by collecting structured and unstructured data from sources including web search, social media, newspaper, and official sources of data; extracting entities and values; providing the entities and values text through multiple neural network text processing pipelines to an ensemblist density processing to generate the entities alignment values.

The present invention relates to systems and methods for determining and aligning values and opinions.

### BACKGROUND

Consumers as a whole are becoming more politically and socially conscious. They buy products from businesses that adhere to their political and social beliefs. For businesses looking to attract new customers, retain existing customers and generally grow their business, the research highlights the importance of brand alignment and marketing company values and ethos to the right audiences. Such is the growing prevalence among consumers to deal with brands that align to their values, that non-alignment can run the risk of consumers shunning certain businesses.

For companies, values define what an organization believes and the behaviors it agrees to live by every day. Values set expectations for how employees behave when interacting with customers, colleagues and partners. Values communicate what is important to the organization and provide clarity and direction for decision-making. Some organizations use the terms guiding principles, company principles and company beliefs interchangeably for values. When thoughtfully developed and effectively implemented, values act as a roadmap to guide business decisions, inspire employees and establish customer loyalty. Stakeholders have values that can be reflected in blogs, opinions, or beliefs formed by people about a topic or issue. Opinions are often expressed in publications or social media comments. However, there is no systematic method for companies to quantify and compare their values with customer values.

### SUMMARY

Systems and methods are disclosed to determine alignment between first and second entities by collecting data from a plurality of sources including web search, social media, newspaper, and official sources of data; extracting entities and values; providing the entities and values text through multiple neural network text processing pipelines to an ensemblist density processing to generate the entities alignment values.

The system helps consumers, companies, and investors to align their actions with their values, opinions, or characteristics, and to unleash a societal impact without any conflict of interest. The system is a platform that quantifies and matches a person, brand, or company on shared personality traits to infer values, opinions, or characteristics. The system is personalized, agnostic, and exhaustive using Natural Language Processing technologies.

### BRIEF DESCRIPTION OF THE DRAWINGS

For the purposes of illustrating the invention, there are shown in the drawing forms which are presently preferred, it being understood, however, that the invention is not limited to the precise arrangements and instrumentalities shown. It is to be understood that both the foregoing general description and the following detailed description are not limiting but are intended to provide further explanation. Further features and advantages, as well as the structure and operation of various embodiments thereof, are described in detail below with reference to the accompanying drawings. The accompanying drawings which are incorporated in and constitute part of the specification are included to illustrate and provide a further understanding of the methods, systems, and computer program products. Together with the description, the drawings explain the principles.

FIG. 1 shows the architecture of an exemplary platform for analyzing sources to qualify and match personality traits between or among entities.

FIG. 2A-2D shows exemplary user interfaces illustrating the API view and the mobile app views of entity information and views of data.

FIG. 2E shows an exemplary traits-stance graph, while FIG. 2F shows an exemplary visual project of different entities.

FIG. 3 show an exemplary process executed by the system of FIG. 1.

FIG. 4 shows exemplary processing pipelines for the system of FIG. 1.

FIG. 5 shows exemplary portal APIs with collector fetcher and score systems.

FIGS. 6-7 show in more details the collectors and the fetchers.

FIG. 8 shows in more details an exemplary social data collector.

FIG. 9 shows an exemplary official source collector.

FIG. 10 shows an exemplary newspaper collector.

FIGS. 11-14 show various implementations of systems to match traits between or among entities, while FIGS. 15A-15B show exemplary value/stance matrices and how they impact the accuracy of trait determination.

### DETAILED DESCRIPTION

The exemplary embodiments consist of major and subsidiary components implemented through a variety of separate and related computer systems. These components may be used either individually or in variety of combinations to achieve the objective of providing a new and improved way to enable content providers to price their specified target audience, for purchase or sale, anytime, based on real-time demand or otherwise, and anywhere without limitation of device platform or an association with content that may limit the distribution of that content. Further, the disclosed embodiments provide for commercialization of price optimization mechanisms within organized electronic marketplaces where rights to access audience profiles and or display space can be traded, in a primary or secondary market.

The term “trait” means a distinguishing characteristic, behavior or quality, especially of a person, company, or an entity's nature. Traits may be formed by an entity's behavior and attitude to others. The trait is a distinguishing quality or characteristic, typically one belonging to a person. It can be a genetically determined characteristic. Traits are formed by a person's behavior and attitude to others. The trait may be a fact or action characterizing affiliation with a value-stance (e.g., participating in or sponsoring gay-pride being a trait inferring that the entity is potentially pro-LGBT).

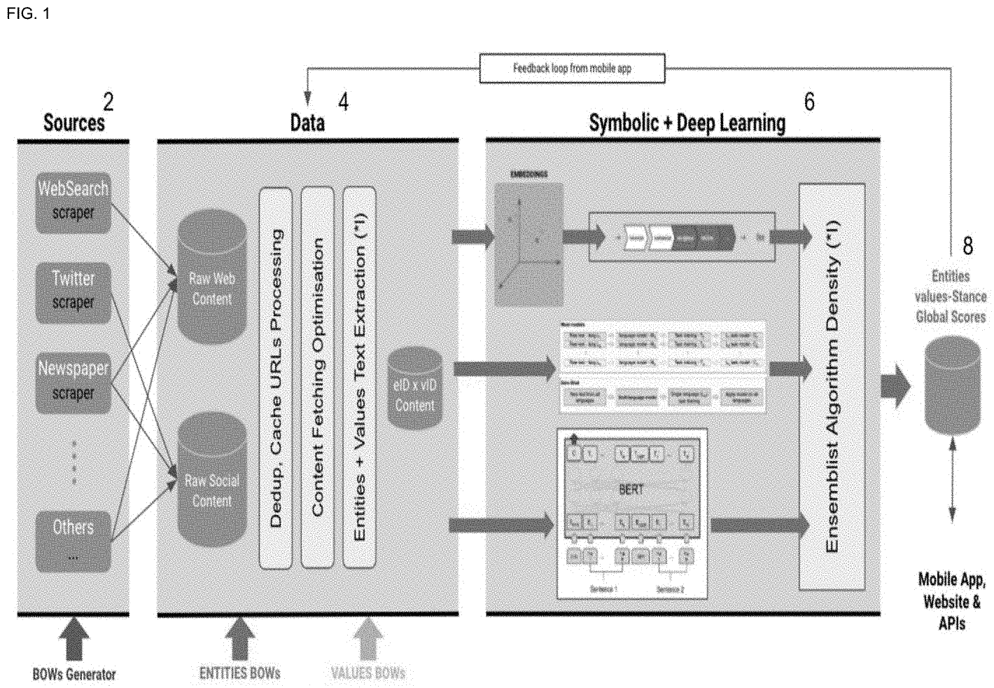

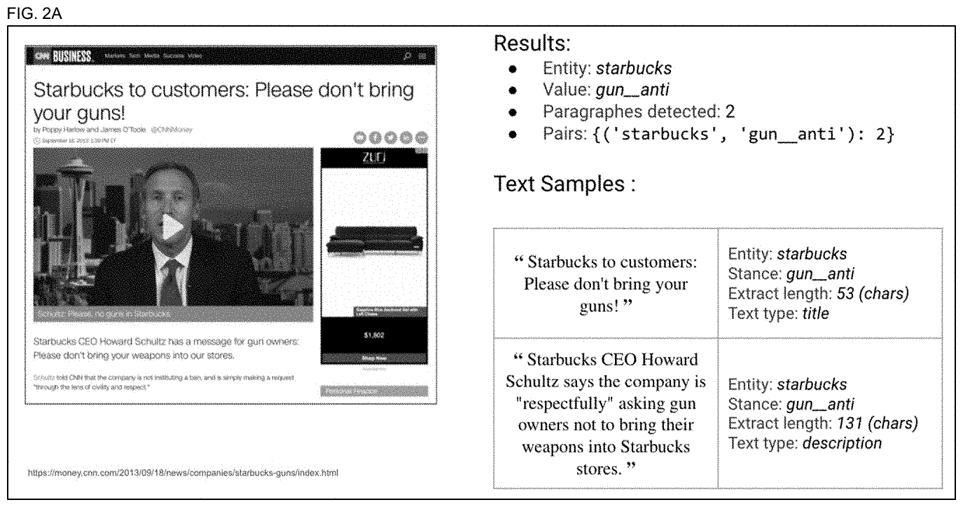

It is noted that the invention is not limited to the specific embodiments described herein. Such embodiments are presented herein for illustrative purposes only. Additional embodiments will be apparent to persons skilled in the relevant art(s) based on the teachings contained herein. The section headings used herein are for organizational purposes only and are not to be construed as limiting the subject matter described. FIG. 1 shows the architecture of an exemplary platform for analyzing sources to qualify and match personality traits between entities. The platform scrapes data from sources module 2 and the content crawled from sources 2 are saved in raw content databases and then pre-processed in data module 4.

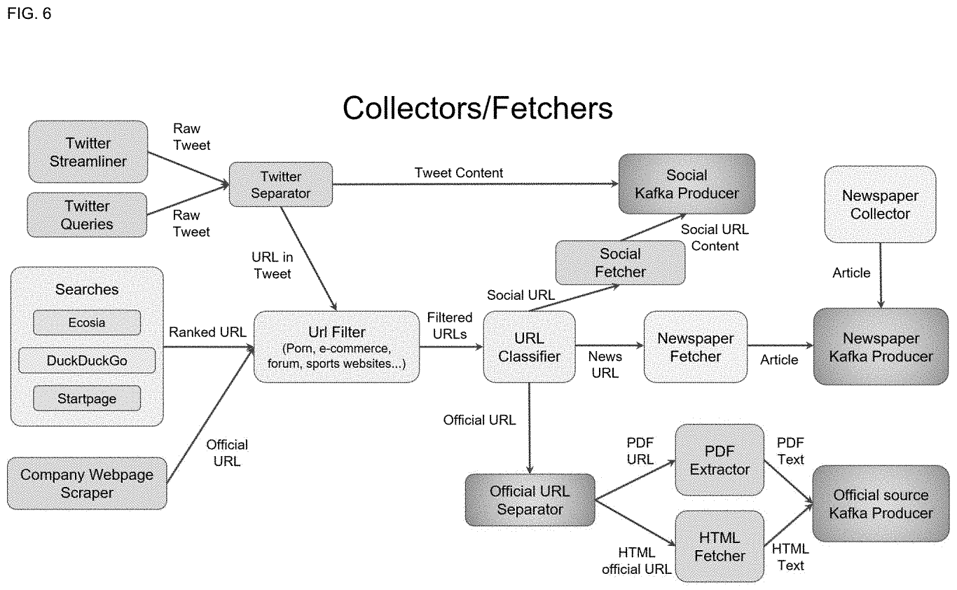

The system collects data from sources 2 using web scrapers that obtain information from various sources of data such as Internet pages, twitter, newspapers, social networks, official sources, and other sources. A bag of word (BOW) generator is applied to the input data sources 2. More details of the data collectors are shown in FIGS. 6-10 below.

The information from the sources module 2 are stored in raw content databases and then pre-processed in data module 4. In addition, data sources distinction and traceability are done in data module 4. The system's end-to-end pipeline preserves the origin of each source of information for accurate traceability and justification of the analysis of the features. This preservation by source provides the flexibility of composition for trait analysis, by a single use of a source or by a weighted average of all or parts of them. The search for traits and their analysis is a cultural notion intimately linked to the form of the information processed, its editor and the process in which it is published. This is why different typologies of data sources are collected, each of which undergoes the appropriate treatment according to their origin.

The Data Source Analysis generates Influence, Expertise and Credibility Scores. The credibility score is based on a parallel quantitative and qualitative analysis of each news source with the addition of an analysis of the influence and expertise of the adjacent social networks of each news source. This approach allows the system to assign a score to each news source, allowing the system to weigh the importance of each news source in the trait analysis of each entity. News sources are automatically detected by the data collection pipeline and then injected into the analysis to confirm their relevance and score. The credibility score allows to reduce fake news by a reverse sociological approach and analysis of social networks (influence, expertise). The trait is represented in one implementation as follows:

# lwd = labels_weight_key
# label_1 => from token predicat
# weight of the label => to applied threshold or sort
# key => dominant (key) or recessive for topic election
topic = [{
‘name’:‘topic_name_1’,
‘lwk’:[
[‘label_1’, 10, False],
[‘label_2’, 1, False],
[‘label_3’, 6, True]
]},{
‘name’:'topic_name_2’,
‘lwk’:[
[‘label_1’, 10, False],
[‘label_2’, 1, False],
[‘label_3’, 6, True]
]
}]

As each newspaper can be influenced by an entity when it publishes information, the system performs societal and sociological analysis axes with, in the long run, an inference of religious and political currents, average polarity, distribution of analysis facts, . . . in order to continuously evolve the score of each source of information to improve the classification of values. In one embodiment, fact checking can be used to automatically analyze articles and check if the paragraphs contain information or facts related to each analyzed trait. The example below performs fact checking on McDonald's recycle packaging:

Exemplary pseudo-code for the determination of the Position Score from the collected webpages of each eID×vID is as follows:

```
  • For each entity, collect daily information (articles/web pages or social
networks). (Collectors)
  • The webpages are filtered to remove porn, ecommerce and forum
websites (Filters)
  • Each webpage is scanned to look for our predefined entities using symbolic
methods → a score of entity detection is computed for each url (Symbolic Pipeline 1)
  • Each webpage is analyzed to check if the words of the value bag of
words are in the webpage resulting in a symbolic value_density score (Symbolic
Pipeline 2)
  • The text content of each webpage is split into paragraphs. Each
paragraph is classified according to their value (BERT Value) and stance (BERT
Stance) (cf. Current Pipeline) and aggregated per URL (Connectionist Pipeline). In
one embodiment, the classification is execute through 2 methods : A. Classification
through BERT classifier fine-tuned with value x stance data annotated by human and
B. Annotation of each paragraph through a self-labelization based on a zero shot
learning with traits defining values x stance following with a classification method to
infer the value x stance in the paragraph.
  • A new value_density is computed from the Connectionist Pipeline and
Symbolic Pipeline results (Density merging)
  • The urls are distributed according to the entities and values that match
with them (Bucket URLs)
  • According to the volume of each vid x eid bucket volume, a position score
is computed for each vid x eid by comparing the pro-vid x eid to its respective anti-vid
x eid (Final score + Global Score)
  • Urls are ranked according to their relevance (Ranking URLs)
  • The url ranking and the scoring per vid x eid is sent to aysrv prod and
stagin
```

In one embodiment, a dynamic calculation of value-stance proximity of two entities by natural language inference (allowing to see if the speeches of a CEO or any key person of a company are aligned with the official communication of a company).

The output of the data module 4 is provided to a symbolic and deep learning module 6. The module's natural language supply chain is based on Natural Language Processing (NLP) and an ensemblist architecture integrating multi-pipelines from symbolic NLP methods and advanced methods such as transformers (BERT, RoBERTa) and Zero-Shot Learning text classification to infer traits and stances.

Such an ensemble of differently configured models can be achieved through the normal process of developing the network and tuning its hyperparameters. Each model could be saved during this process and a subset of better models chosen to comprise the ensemble. In cases where a single model may take weeks or months to train, another alternative may be to periodically save the best model during the training process, called snapshot or checkpoint models, then select ensemble members among the saved models. This provides the benefits of having multiple models trained on the same data, although collected during a single training run.

A further enhancement of the snapshot ensemble is to systematically vary the optimization procedure during training to force different solutions (i.e. sets of weights), the best of which can be saved to checkpoints. This might involve injecting an oscillating amount of noise over training epochs or oscillating the learning rate during training epochs. A variation of this approach called Stochastic Gradient Descent with Warm Restarts (SGDR) demonstrated faster learning and state-of-the-art results.

A benefit of very deep neural networks is that the intermediate hidden layers provide a learned representation of the low-resolution input data. The hidden layers can output their internal representations directly, and the output from one or more hidden layers from one very deep network can be used as input to a new classification model. This is perhaps most effective when the deep model is trained using an autoencoder model. This type of ensemble is referred to as a vertical ensemble.

One embodiment combines the predictions by calculating the average of the predictions from the ensemble members. This can be improved slightly by weighting the predictions from each model, where the weights are optimized using a hold-out validation dataset. This provides a weighted average ensemble that is sometimes called model blending.

In one embodiment, the ensemblist architecture uses an NLP engine core designed to reproduce a logic close to the steps that a human being could perform in order to analyze the features of an entity:
1. Definition of the traits (values, opinion, . . . ) according to a general representation by the large number.
2. Research of information related to the entity with the focus of the traits on different sources (see types of data sources).
3. Attribution of a credibility to each source by the analysis of a credibility score (a term color of the source)
4. Analysis of each article or information with numerous criteria: extraction based on NER, inference of traits by token similarity, fine tuned BERT inference based on weak annotation strategy (data efficiency) as well as pre-labellisation by BERT Zero-shot learning to add trait labels to the text before executing an inference or classification. This step allows the system to isolate each paragraph of an article, extract the DNA from it and categorize it with the right pair of entity and trait, as well as pre-labelization by Zero-shot learning to add trait labels to the text before executing an inference or classification.

As discussed above, a trait may be a fact or action characterizing affiliation with a value-stance (e.g., participating in or sponsoring gay-pride being a trait inferring that the entity is potentially pro-LGBT). In one implementation, the trait can be represented as:

# lwd = labels_weight_key
# label_1 => from token predicat
# weight of the label => to applied threshold or sort
# key => dominant (key) or recessive for topic election
topic = [{
‘name’:'topic_name_1’,
‘lwk’:[
[‘label_1’, 10, False],
[‘label_2’, 1, False],
[‘label_3’, 6, True]
]},{
‘name’:‘topic_name_2’,
‘lwk’:[
[‘label_1, 10, False],
[‘label_2’, 1, False],
[‘label_3’, 6, True]
]
}]

At the end of step 4, the system counts a set method (mean, harmonic mean, random forest, decision tree, . . . ) of categorization inferences in order to smooth over time (short, medium, long) the relative distribution of trait presence for each entity.

The NLP engine core is supported by a close relationship with the user community through a user feedback loop function to finalize the models by updating the data by mobile application users. User feedback is used by weighting the distribution of their feedback in an active learning or reinforcement learning approach.

The scalability and diversity of NLP analysis entity management also requires the rapid integration of new entities. To support the scalability of the number of entities (companies, organizations, groups, individuals, . . . ), the core NLP engine integrates dynamic online search mechanisms to automatically collect companies, their domains, sectors, key collaborators and many other information. To support both the analysis of the data collected daily and the flexibility of the search engine in the application and the future partner portal, the core engine integrates within its clustering mechanisms and semantic projection of integers. The approach, based on the notions of semantic projection with high-dimensional spaces, allows the system to dynamically reconstruct the proximity of entities which, in the case of a company, also allows the system to understand that brands such as Malboro are very involved in car competition or to understand that Uber and General Motors are in the closed field. These analyses are not limited to companies and can be extended to all types of entities. This approach allows the system to dynamically rebuild entity ontologies by a symbolic and connective approach, allowing the system to also give complementary and non-parametric dimensions (categories, location, sub-domains, articles, services, products, . . . ) on value-stance or trait analysis.

In zero-shot learning (ZSL) the system applies a classifier (BERT or BART, among others) on one set of labels and then evaluates on a different set of labels that the classifier has never seen before. Traditional zero-shot learning requires providing descriptors for an unseen class (such as a set of value-stance trait attributes) in order for a model to be able to predict that class without training data. For example, Sentence-BERT fine-tunes the pooled BERT sequence representations for increased semantic richness in obtaining sequence and label embeddings.

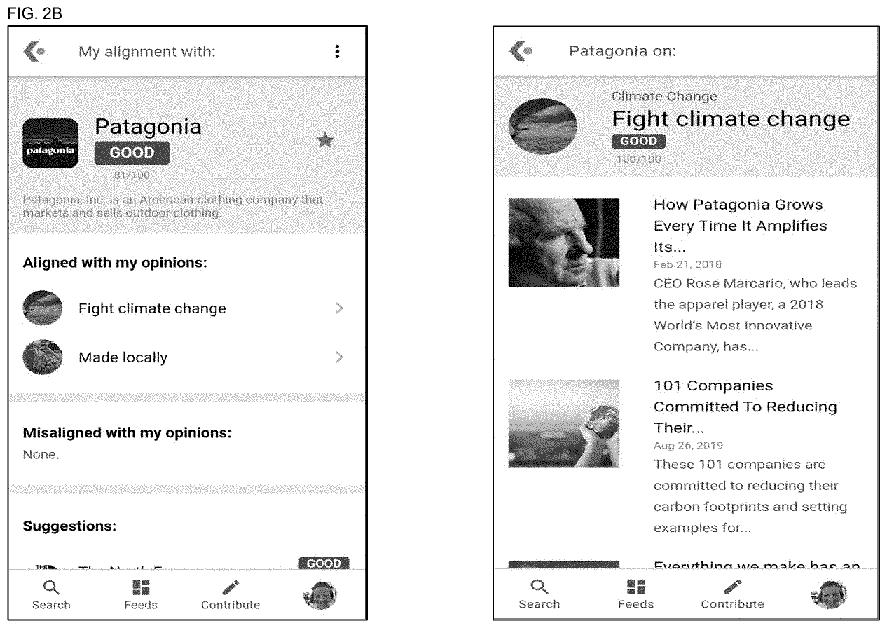

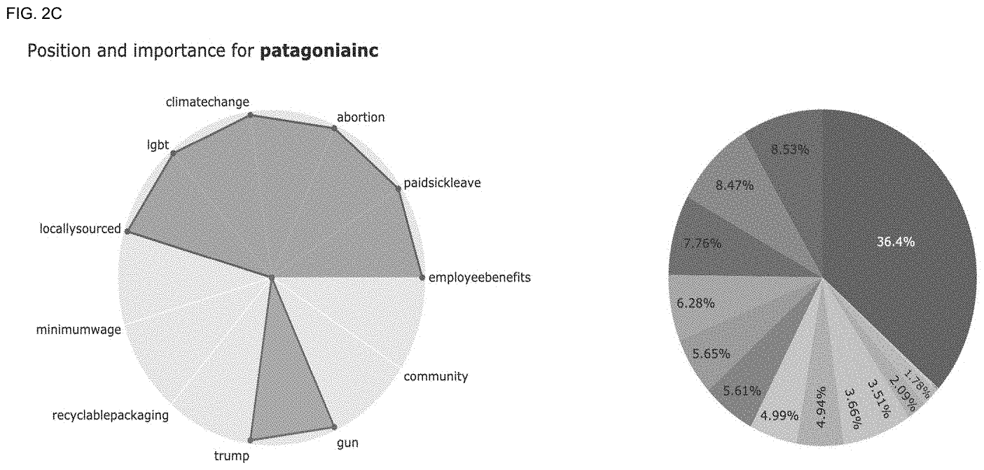

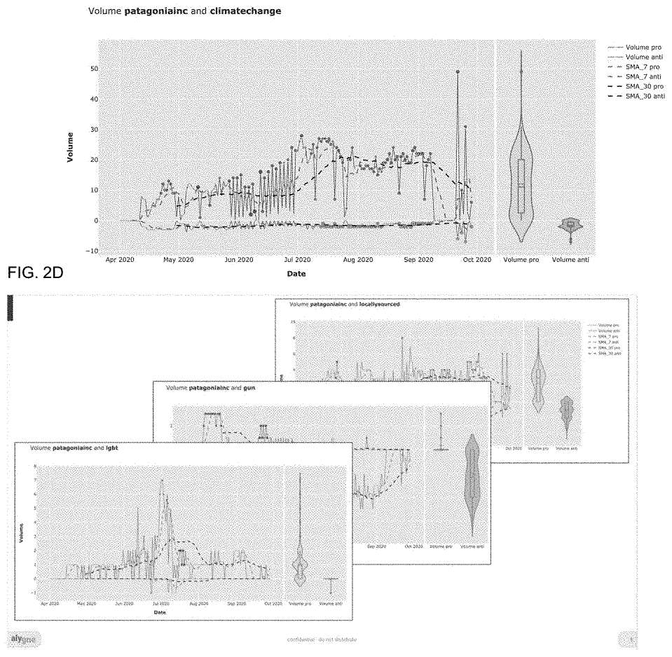

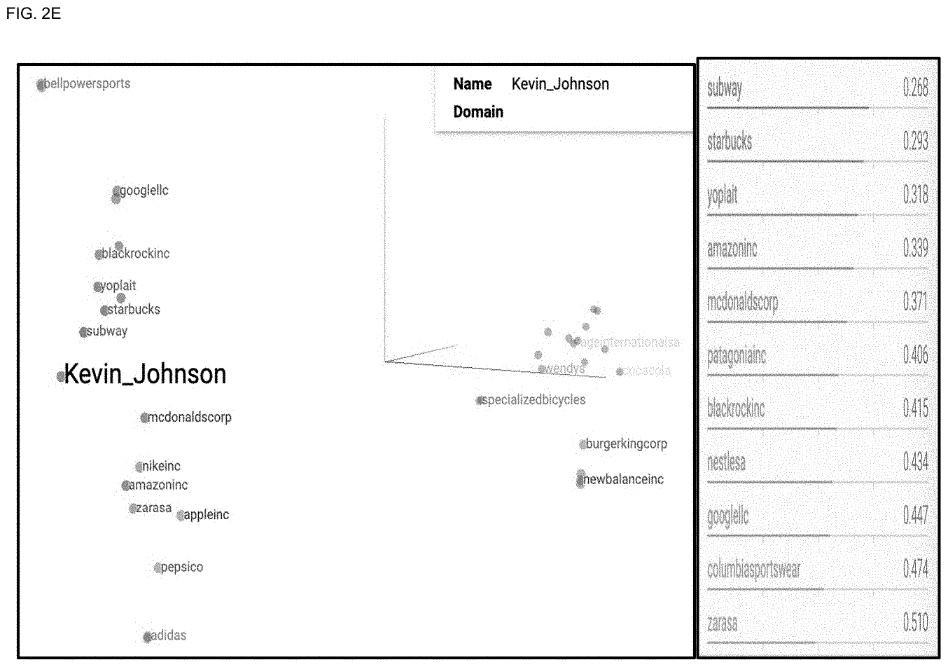

FIG. 2A-2D shows exemplary user interfaces illustrating the API view and the mobile app views of entity information and views of data. FIG. 2A shows an exemplary Entities News Timeline. For each entity, the engine brings up all the most relevant articles per trait-stance with all the information and features of each of them. FIG. 2B shows exemplary API's view—News/Article with features extracted and exemplary mobile-app's views—Patagonia traits Fight Climate Change and News. FIG. 2C shows exemplary Analytics, Mobile App & API. Prior to delivery to the mobile application to allow the system community to form its own opinion and provide feedback to the engine to finetune the models, the NLP Core Engine publishes a daily analysis report for each entity with different views of the data being analyzed:
General: smooth view of the features of an entity
Over 7 or 30 days: allowing to smooth the entropies.
Daily: to identify weak signals

FIG. 2D shows an example analysis of Patagonia's Climate-Change trait based on Patagonia's Locally Sourced, Gun & LGBT traits from April 2020 to October 2020. The diagrams show the details of the traits-stance of Patagonia as an entity. Different data analyses can be done: daily, over 7 or 30 sliding days as well as from the first day of collection. This approach allows not only to follow the evolution of the traits of an entity over time but also to detect any entropy that may be an event to be followed or smoothed by the large number.

FIG. 2E shows an exemplary traits-stance graph. In FIG. 2E, the emergence of the traits-stance graphs allows the system to detect phenomena such as the duality of entities trying to display certain position and being pulled by the press or social networks towards the opposite position as we can notice it on the Soulcyle entity which tries to keep a neutral position on the line for or against Trump while it inherits, from its shareholders, a pro-Trump position.

FIG. 2F shows an exemplary visual project of different entities. In FIG. 2E, the visual projection results of different entities (companies and CEO per company) are used to calculate the distance of the strokes between different entities based on their direct language. The left chart shows the semantic projection of Kevin Johnson (tweets, hashtags, urls) in the inferred values space of corporate entities while the right chart shows an exemplary cosine distance from Kevin Johnson with a list of business entities.

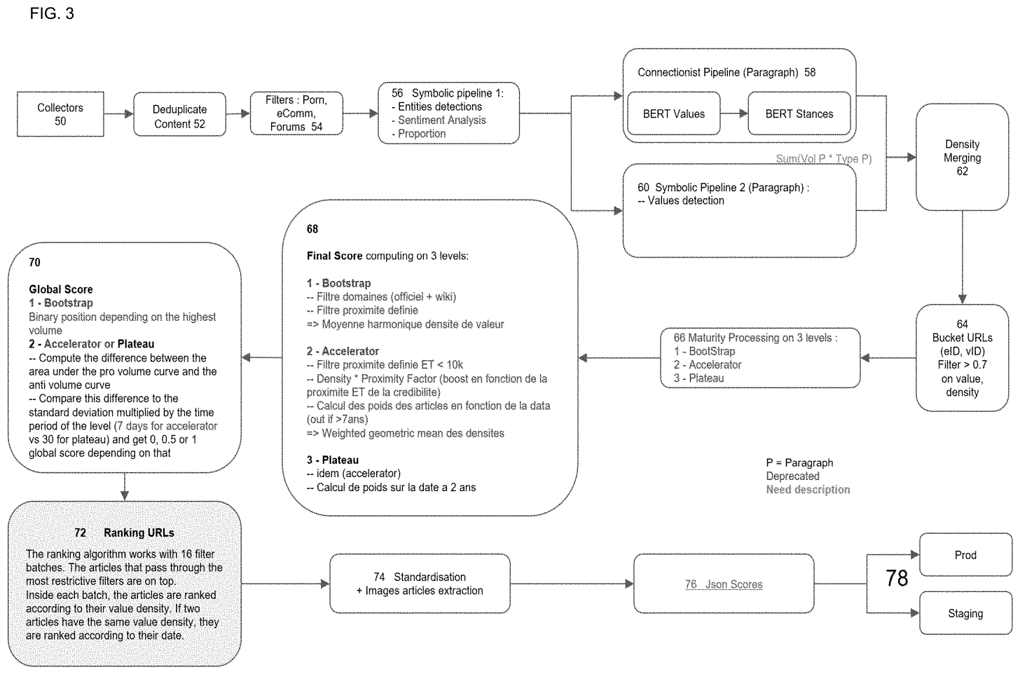

FIG. 3 show an exemplary process executed by the system of FIG. 1. In FIG. 3, data from collectors 50 are provided to be deduplicated in 52 and then filters are applied to remove items such as porns, electronic communications, and forums in 54. In 56, a symbolic pipeline is applied for entity detection, sentiment analysis, and proportion. Next the data is provided to a connectionist pipeline 58 that converts transformer values to stances, for example BERT values to BERT stances, as well as a symbolic pipeline 64 for values detection.

One implementation can analyze the text according to two approaches, the first being a BERT finetune value classification on manually annotated data for each value before being presented to a second finetune stance classification on manually annotated data, a general stance model is also used for low data volume values for the stance classification. The second method is based on a self-supervised learning integrating a zero shot learning method on a generalist model of type BART or GPT having a good representation of the world from a semantic point of view in order to annotate the data on a basis of predicates representative of features allowing to characterize the values-stances. These labels are then assigned to the data to be analyzed, the value-stance of this one can be inferred by a simple classifier or any other form of regression.

which will analyze the text according to two approaches, the first being a BERT finetune value classification on manually annotated data for each value before being presented to a second finetune stance classification on manually annotated data, a general stance model is also used for low data volume values for the stance classification. The second method is based on a self-supervised learning integrating a zero shot learning method on a generalist model of type BART or GPT having a good representation of the world from a semantic point of view in order to annotate the data on a basis of predicates representative of features allowing to characterize the values-stances. These labels are then assigned to the data to be analyzed, the value-stance of this one can be inferred by a simple classifier or any other form of regression.

The outputs of the two pipelines are provided to a density merging module 62 and the bucket URLs are captured in 64. Next, in 66, maturity processing is applied on 3 levels: bootstrap, accelerator and plateau. In 68, a final score is computed for the three levels: bootstrap level, accelerator level, and plateau level. Then in 70, a global score is computed. The global store can be determined on bootstrap, accelerator, or plateau. The data is ranked in 72 where the ranking algorithm works with a plurality of filter batches. The articles are passed through the most restrictive filters or on top. Inside each batch, the articles are ranked according to the value density. If two articles have the same value density, D are ranked according to their date. The resulting data is in standardized and images are extracted from articles in 74. Next in 76, Jason scores are determined. The data is then selected in 78 for either production or staging purposes.

One implementation analyzes the text according to two approaches, the first being a BERT finetune value classification on manually annotated data for each value before being presented to a second finetune stance classification on manually annotated data, a general stance model is also used for low data volume values for the stance classification. The second method is based on a self-supervised learning integrating a zero shot learning method on a generalist model of type BART or GPT having a good representation of the world from a semantic point of view in order to annotate the data on a basis of predicates representative of features allowing to characterize the values-stances. These labels are then assigned to the data to be analyzed, the value-stance of this one can be inferred by a simple classifier or any other form of regression.

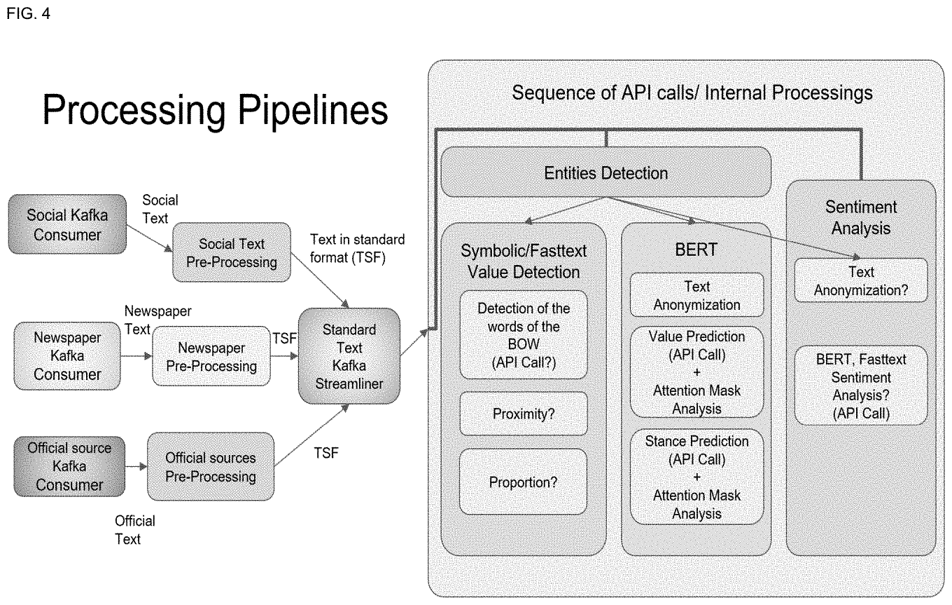

FIG. 4 shows exemplary processing pipelines for the system of FIG. 1. Initially social text data is preprocessed into a standard format text such as TSF, among others. Similarly, newspaper text is preprocessed into TSF and official text is preprocessed into TSF. The standard text is then provided to a streamliner module which is then provided to a sequence of API calls for processing. The standard text is provided to an entities detection module and a sentiment analysis module. In the entities detection module, symbolic or fasttext value detection is done as well as ZSL pre-annotation or BERT processing. In the sentiment analysis text anonymization is detected and then a sentiment analysis is performed using BERT/fasttext.

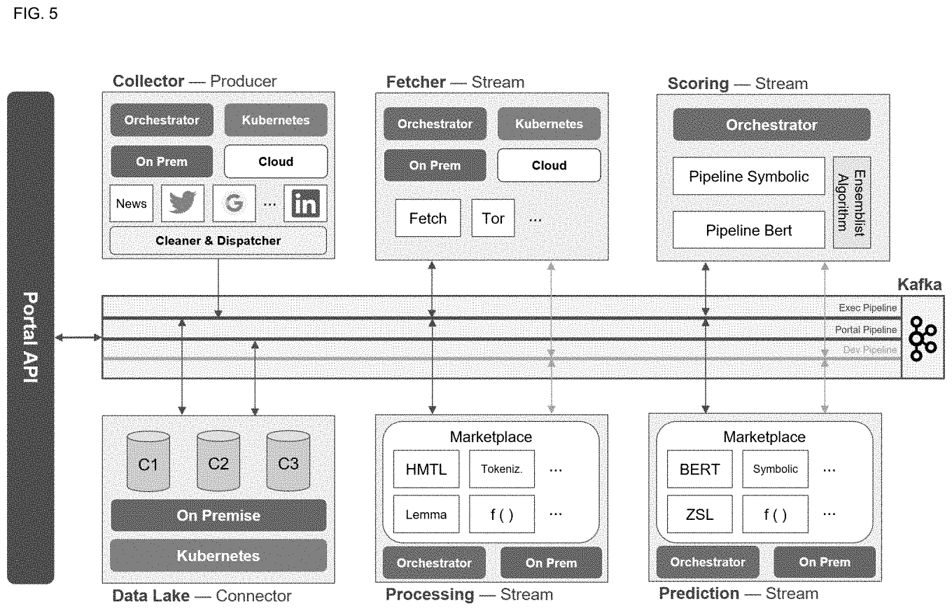

FIG. 5 shows exemplary portal APIs with collector fetcher and score systems. In this system, data collectors capture data from news, social media. Kafka is essentially used for what it was designed for as a sequential message bus allowing to deploy instances of each collection, processing, fetching, scoring box at scale. A data lake is a storage repository that holds a vast amount of raw data in its native format until it is needed. While a hierarchical data warehouse stores data in files or folders, a data lake uses a flat architecture to store data.

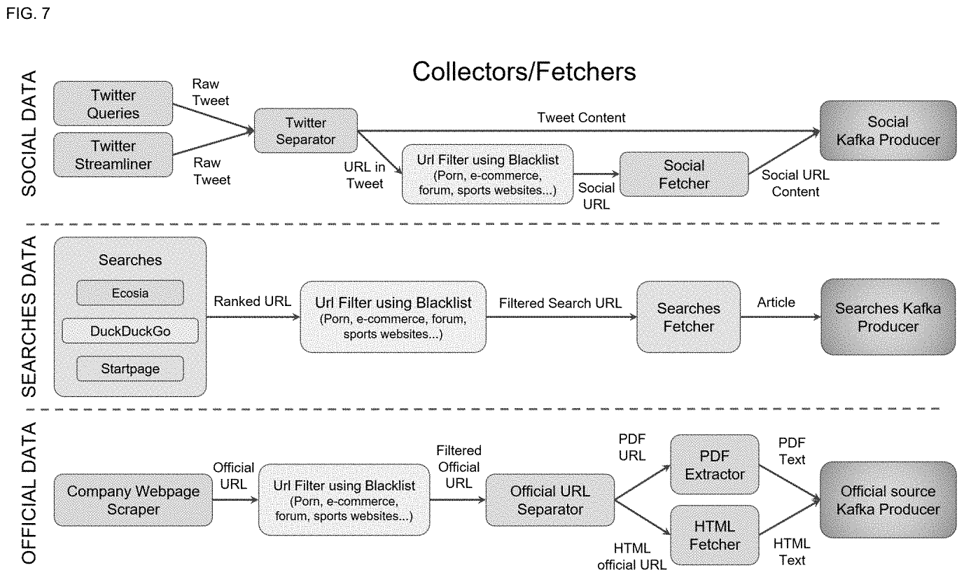

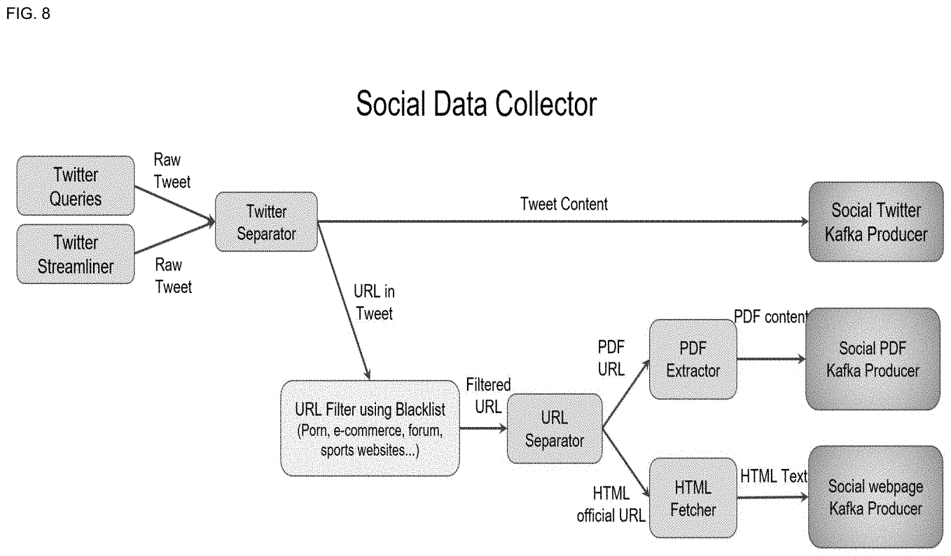

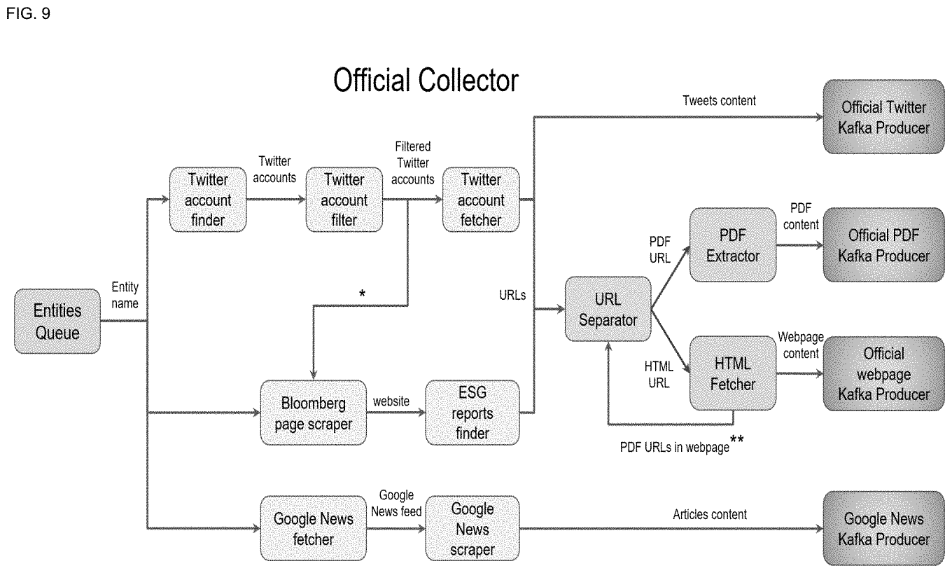

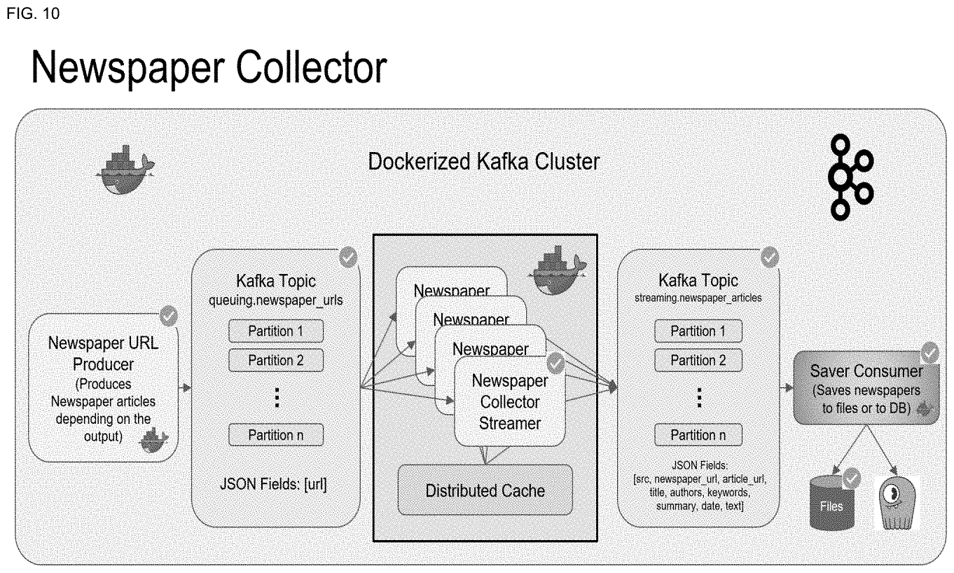

FIGS. 6-7 show in more details exemplary data collectors and the fetchers. FIG. 8 shows in more details an exemplary social data collector. FIG. 9 shows an exemplary official source collector. FIG. 10 shows an exemplary newspaper collector. Official sources allow the system to analyze the official communication of the entities, their messages as well as the image they want to project on the market. Examples include official websites or reports of each company, financial/investor sites, company LinkedIn pages, official Twitter accounts, . . . among others. Newspapers data source, categorized by language, country/region, allows the collection of free or entity-influenced professional data. It represents a second form of indirect communication of the entities colored by the origin of the newspaper. The system automatically finds each newspaper which is analyzed in order to give it a legitimacy score allowing the ranking of each of them. This ranking is based on a quantitative and qualitative analysis combined with an analysis of influence and expertise using language alignment analysis algorithms. Social Networks are monitored in order to retrieve all the exchanges related to the entities to be monitored as well as to detect the networks of each entity in order to reconstruct an ontological (relational) view of the entities between them (e.g. a company with its shareholders, CEO, board, executive committee), these relational models are automatically built by specially implemented models.

Social Network Analysis can be done. The data collection of social networks makes it possible to capture and process a third form of data closer to the voice of citizens and to the voice of customers. Although the data can be broken down into 3 parts (text content, hashtags and urls), it must be exploited with the clear objective of giving an indication of the features of an entity. In this sense, it can be direct or indirect, meaning direct by the form of data published directly by the entity and indirect by the form of data published by users in relation to the entity. To minimize the impact of bots, a Human-Bot classifier is applied based on the semantics of twitter accounts. The implemented classifiers also process only content directly related to the entities-traits to infer its opinions and/or values.

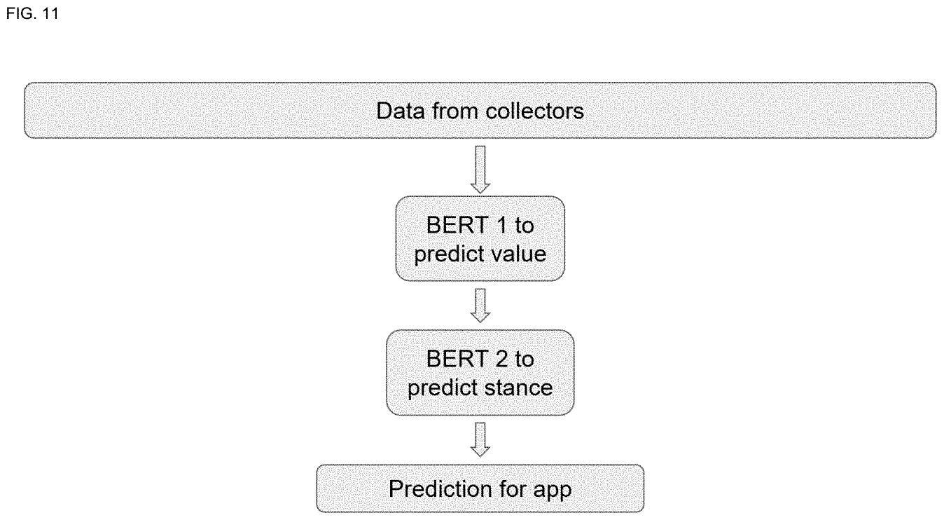

FIGS. 11-14 show various implementations of systems to match traits between or among entities. FIG. 11 shows an embodiment that receives data from the collectors and then provides the data to two BERT models, the first to predict value and the second to predict stance. The result is provided as a prediction to an app, a web site, or a suitable user interface (UI). One implementation analyzes the text according to two approaches, the first being a BERT finetune value classification on manually annotated data for each value before being presented to a second finetune stance classification on manually annotated data, a general stance model is also used for low data volume values for the stance classification. The second method is based on a self-supervised learning integrating a zero shot learning method on a generalist model of type BART or GPT having a good representation of the world from a semantic point of view in order to annotate the data on a basis of predicates representative of features allowing to characterize the values-stances. These labels are then assigned to the data to be analyzed, the value-stance of this one can be inferred by a simple classifier or any other form of regression.

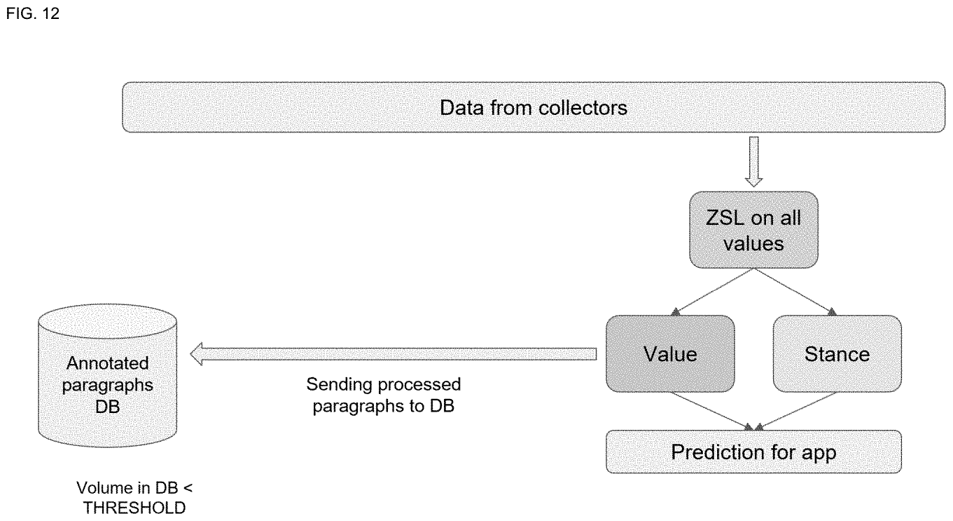

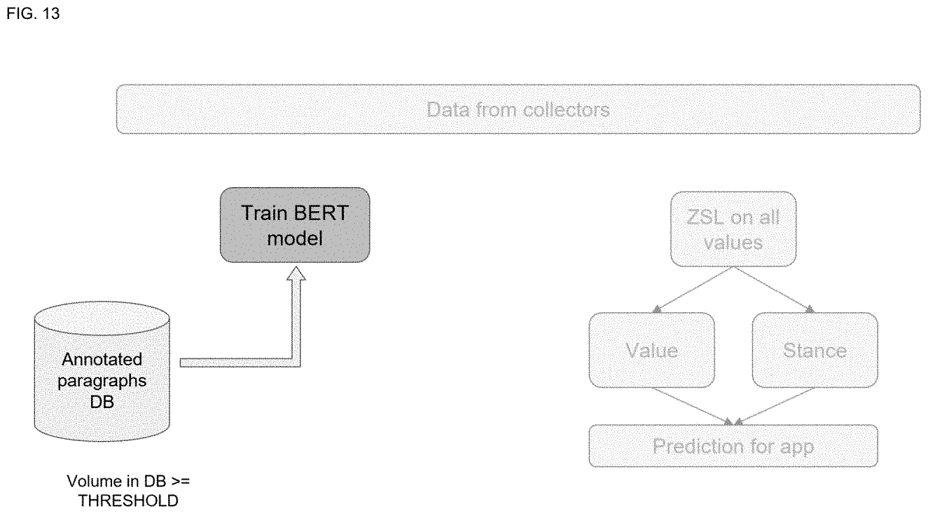

FIG. 12 shows an exemplary value on-boarding system. Data is received from collectors and ZSL is applied to all values. The value output is provided as processed paragraphs to an annotated paragraph database. The value and stance output is provided as predictions for the app, website, or UI. The value/stance pipeline applies the ZSL as described with a first step of evaluating the value by a subset of traits and then filtering on a larger set of traits to detect the stance. This bootstrap operation can save the results on the detections of values/features in order to constitute a dataset to train in a second time a BERT model on the integrated values. The data from the annotated paragraph database is used to train the BERT model, as shown in FIG. 13, and the trained BERT model is used in FIG. 12. The operation of FIG. 13 can be done in parallel with FIG. 12, and from a certain volume of paragraphs or sentences, the system can start the training of a BERT model which will then be used to accelerate the processing time of the data.

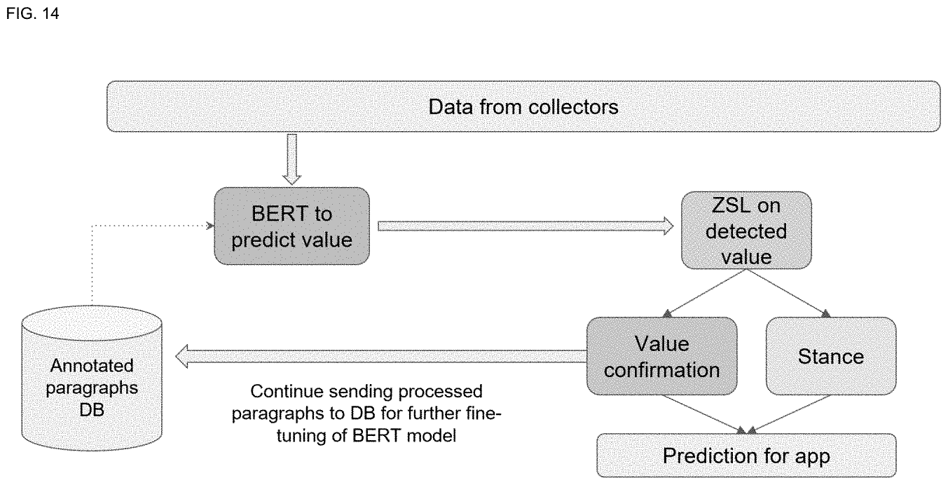

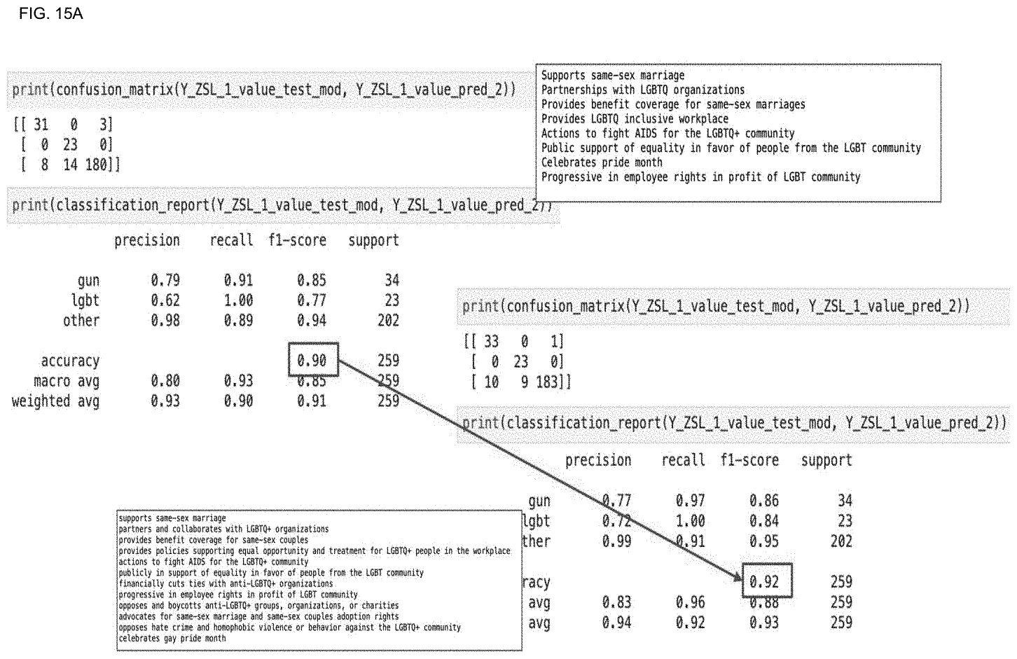

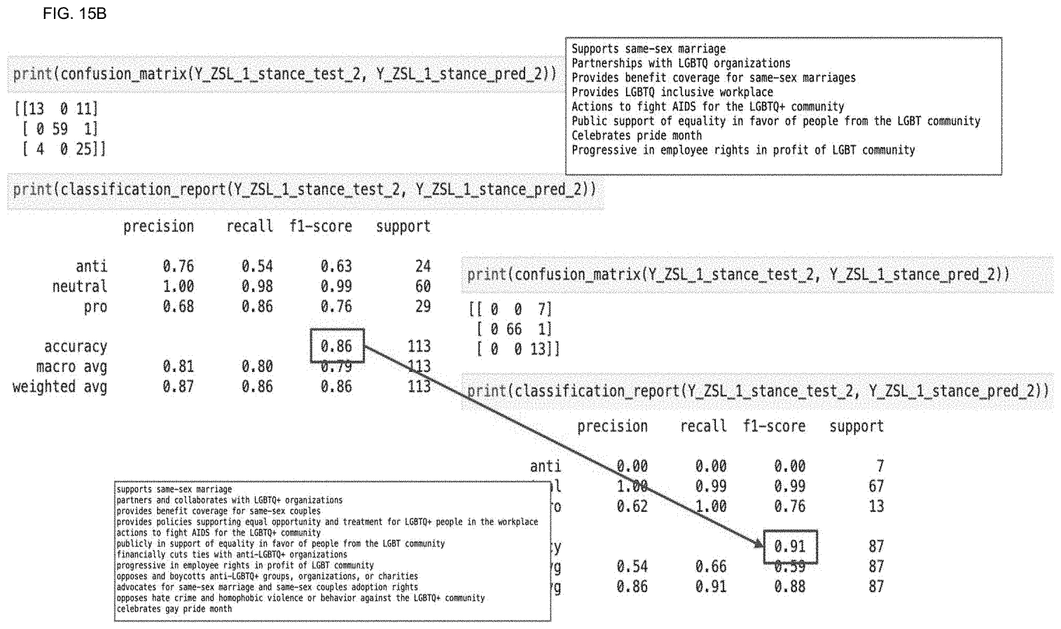

FIG. 14 shows an exemplary embodiment with the ensemblist model. In FIG. 14, data from collectors are provided to the trained BERT to predict value. The BERT output is provided to the ZSL model based on the detected values. The ZSL model generates the value confirmation and the stance output, both of which are used to generate the prediction for the app, website, or UI as before. Further, the value confirmation is provided to the annotated paragraph database. Once the BERT model is trained and the values are stable, the BERT model takes over the detection of the values with a lighter ZSL support (because the ZSL is very costly in time and energy). The rest of the pipeline remains the same.

Exemplary matrices for the value and stance data generated by the BERT model are shown below:

For the foregoing BERT and ZSL value and stance determinations, FIGS. 15A-15B show how the above exemplary value/stance matrices can impact the accuracy of trait determination. In the example of FIG. 15A, the correct description of the inference features for the ZSL on the values can have an impact of a few points on the detection of the values. On the left of FIG. 15A, the ZSL model with a score of 90% plays on a smaller list of features (see the top right tile) while the ZSL on the right with a longer list of features giving more precision (see the bottom left tile) can give a score of 92%. The example of FIG. 15B shows that the impact is even stronger on the stance detection where the accuracy is increased from 86% to 91% in this case.

Exemplary pseudo-code for major modules of the above system is detailed next.

Embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions. Computer readable program instructions described herein can be stored in memory or downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. Computer readable program instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Python has a large amount of libraries for implementing sentiment analysis or machine learning from scratch. NLTK, or the Natural Language Toolkit, or tools such as ANN(RNN) with FastText, Gensim or Spacy can be used for sentiment analysis. It provides useful tools and algorithms such as tokenizing, part-of-speech tagging, stemming, and named entity recognition. SpaCy is an industrial-strength NLP library in Python which can be used for building a model for sentiment analysis. It provides interesting functionalities such as named entity recognition, part-of-speech tagging, dependency parsing, and word vectors, along with key features such as deep learning integration and convolutional neural network models for several languages. Scikit-learn is a machine learning toolkit for Python that is excellent for data analysis. It features classification, regression, and clustering algorithms. TensorFlow is the dominant framework for machine learning in the industry. It has a comprehensive ecosystem of tools, libraries, and community resources that lets developers implement state-of-the-art machine learning models. PyTorch is another popular machine learning framework that is mostly used for computer vision and natural language processing applications. Developers love PyTorch because of its simplicity; it is very pythonic and integrates really easily with the rest of the Python ecosystem. PyTorch also offers a great API, which is easier to use and better designed than TensorFlow's API. Keras is a neural network library written in Python that is used to build and train deep learning models. It is used for prototyping, advanced research, and production. CoreNLP is Stanford's proprietary NLP toolkit written in Java with APIs for all major programming languages. It is powerful enough to extract the base of words, recognize parts of speech, normalize numeric quantities, mark up the structure of sentences, indicate noun phrases and sentiment, extract quotes, and much more. OpenNLP is an Apache toolkit designed to process natural language text with machine learning. It supports language detection, tokenization, sentence segmentation, part-of-speech tagging, named entity extraction, chunking, parsing, and conference resolution. Weka is a set of machine learning algorithms for data mining tasks. It includes tools for data preparation, classification, regression, clustering, association rules mining, and visualization. R is a programming language that is mainly used for statistical computing. Its most common users include statisticians and data miners looking to develop data analysis. Caret package includes a set of functions that streamline the process of creating predictive models. It contains tools for data splitting, pre-processing, feature selection, model tuning via resampling, and variable importance estimation. Mir is a framework that provides the infrastructure for methods such as classification, regression, and survival analysis, as well as unsupervised methods such as clustering.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments.

Additionally, it is understood in advance that the teachings recited herein are not limited to a particular computing environment. Rather, embodiments are capable of being implemented in conjunction with any type of computing environment now known or later developed. For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. The software/system may be offered based the following service models:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

A cloud computing environment is service oriented with a focus on statelessness, low coupling, modularity, and semantic interoperability. At the heart of cloud computing is an infrastructure comprising a network of interconnected nodes. Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some implementations, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein a “user interface” (also referred to as an interactive user interface, a graphical user interface or a UI) may refer to a network based interface including data fields and/or other controls for receiving input signals or providing electronic information and/or for providing information to the user in response to any received input signals. A UI may be implemented in whole or in part using technologies such as hyper-text mark-up language (HTML), ADOBE® FLASH®, JAVA®, MICROSOFT®.NET®, web services, and rich site summary (RSS). In some implementations, a UI may be included in a stand-alone client (for example, thick client, fat client) configured to communicate (e.g., send or receive data) in accordance with one or more of the aspects described.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims or requested exclusivity rather than by the foregoing description. All changes that come within the meaning and range of equivalency of the requested exclusivity are to be embraced within their scope.

What is claimed is:

1. A method to determine alignment between first and second entities, comprising:
collecting structured and unstructured data from sources including web search, social media, newspaper, and official sources of data;
extracting entities and values;
providing the entities and values text through a symbolic text processing pipeline and multiple neural network text processing pipelines using ensemblist density processing to generate the entities alignment values.

2. The method of claim 1, comprising scraping data from data sources including social media threads, newspapers, and company data sources and generating bag-of-words from the data sources.

3. The method of claim 1, wherein the extracting step comprises applying data from verified databases on each company to form an entity bag of words and applying data from a crowd-sourced content to form a value bag of words.

4. The method of claim 1, comprising generating bag-of-words for the entities and values and storing data as eID and vID.

5. The method of claim 1, comprising performing symbolic processing on the data before applying ensemblist density to the data.

6. The method of claim 1, wherein the symbolic processing comprises applying NLP to bootstrap data.

7. The method of claim 1, comprising applying a classifier or a transformer to bootstrap classification of alignment.

8. The method of claim 1, comprising applying a zero shot classifier to bootstrap classification of alignment.

9. The method of claim 1, comprising receiving data from mobile apps and generating entity values and stance as feedback data.

10. The method of claim 1, comprising integrating the multi-pipelines from symbolic NLP methods and transformers (BERT, RoBERTa) and Zero-Shot Learning text classification to infer traits and stances.

11. The method of claim 1, comprising performing ensemblist processing to determine alignment of values from the first and second entities.

12. The method of claim 1, comprising defining traits including value or opinion according to a general representation.

13. The method of claim 1, comprising searching information related to the entity with the focus of the traits on different sources.

14. The method of claim 1, comprising attributing a credibility to each source by the analysis of a credibility score.

15. The method of claim 1, comprising analyzing each article or information with criteria: extraction based on NER, inference of traits by token similarity, fine tuned BERT inference based on weak annotation strategy and inference by BERT zero-shot learning.

16. The method of claim 1, comprising counting a set method of categorization inferences to smooth over time a relative distribution of trait presence for each entity.

17. The method of claim 1, comprising training a learning machine to recognize the traits characterizing values-stances through natural language.

18. The method of claim 1, comprising performing dynamic calculation of value-stance proximity of two entities by natural language inference.

19. The method of claim 1, comprising

20. A method to determine alignment between first and second entities, comprising:
collecting structured and unstructured data from sources including web search, social media, newspaper, and official sources of data;
extracting entities and values;
determining value and stance with traits;
providing the value and stance traits to a zero shot learning (ZSL) architecture and generating an inference to detect the value stance and to generate the entities alignment values.

21. The method of claim 20, comprising a minimum of 3 to 8 traits.

22. The method of claim 20, comprising inferring each trait by one of: token similarity, fine tuned BERT inference based on weak annotation, or zero-shot learning.

23. The method of claim 20, comprising pre-labelizing by BERT Zero-shot learning to add trait labels to text before executing an inference or classification.

24. The method of claim 20, wherein the ZSL architecture comprises BART, BERT GPT.

25. A method to identify traits associated with an entity, comprising:
collecting structured and unstructured data from sources including web search, social media, newspaper, and official sources of data;
extracting entities and values; and
training a learning machine to recognize the traits characterizing values-stances through natural language processing.

26. The method of claim 24, wherein the learning machine comprises one of: TF, TF-IFD, clusterization, and acts detection.

27. A method to determine alignment between first and second entities, comprising:
collecting structured and unstructured data from sources including web search, social media, newspaper, and official sources of data;
extracting entities and values;
providing the value and stance traits to a zero shot learning architecture and generating an inference to detect the value stance; and
using ensemblist density processing to generate the entities alignment values.
